(19) United States
(12) Patent Application Publication
(10) Pub. No.: US 2012/0130696 A1
(43) Pub. Date: May 24, 2012

(54) Optimizing Well Management Policy

(75) Inventors: Jeffrey E. Davidson, Pearland, TX (US); Federico Carvallo, Sugar Land, TX (US); Cassandra M. McZeal, Houston, TX (US); Pengbo Lu, Sugar Land, TX (US)

(73) Assignee: EXXONMOBIL UPSTREAM RESEARCH COMPANY, Houston, TX (US)

(21) Appl. No.: 13/382,835

(22) PCT Filed: May 12, 2010
(86) PCT No.: PCT/US2010/034560

§ 371 Date: Jan. 6, 2012

Related U.S. Application Data
(60) Provisional application No. 61/233,362, filed on Aug. 12, 2009.

(51) Int. Cl. G06G 7/57

(52) U.S. Cl. 703/10

(57) ABSTRACT

A field operating policy for a subsurface region is optimized by setting initial policy parameters for the subsurface region. Fluid flow within a subsurface region is simulated, wherein the simulation includes optimizing an objective function for field operating policy, the objective function corresponding simultaneously to the modeled fluid flow characteristics of one or more wellbores within the subsurface region and relating to at least one production system performance parameter. Optimizing the objective function for field operating policy may include optimizing the initial policy parameters for the subsurface region with an over time optimization technique, wherein the policy parameters are optimized for a predetermined policy period. An enhanced value of the objective function is determined at each timestep within the predetermined policy period. The optimized policy parameters for the predetermined policy period may serve as constraints in the determination of an enhanced value of the objective function at each timestep within the predetermined policy period.

### CROSS REFERENCE TO RELATED APPLICATION

This application claims the benefit of U.S. Provisional Application 61/233,362, filed Aug. 12, 2009, entitled OPTIMIZING WELL MANAGEMENT POLICY, the entirety of which is incorporated by reference herein.

### TECHNICAL FIELD

This description relates generally to oil and gas production, and more particularly to optimizing well management policy in the context of reservoir development planning.

### BACKGROUND

Developing and managing petroleum resources often entails committing large economic investments over many years with an expectation of receiving correspondingly large financial returns. Whether a petroleum reservoir yields profit or loss depends largely upon the strategies and tactics implemented for reservoir development and management. Reservoir development planning involves devising and/or selecting strong strategies and tactics that will yield favorable economic results over the long term.

Reservoir development planning may include making decisions regarding size, timing, and location of production platforms as well as subsequent expansions and connections. Key decisions can involve the number, location, allocation to platforms, and timing of wells to be drilled and completed in each field. Post drilling decisions may include determining production rate allocations across multiple wells. Any one decision or action may have system-wide implications, for example propagating positive or negative impact across a reservoir immediately and/or over time. In view of the aforementioned aspects of reservoir development planning, which are only a representative few of the many decisions facing a manager of petroleum resources, one can appreciate the value and impact of planning.

Computer-based modeling holds significant potential for reservoir development planning, particularly when combined with advanced mathematical techniques. Computer-based planning tools support making good decisions. One type of planning tool includes methodology for identifying an optimal solution to a set of decisions based on processing various information inputs. For example, an exemplary optimization model may work towards finding solutions that yield the best outcome from known possibilities with a defined set of constraints. Accordingly, a petroleum operation may achieve great economic benefit via properly applying optimization models for optimizing the development plans and management of petroleum resources, particularly those involving decision-making for multiple oil or gas fields over many years.

A typical reservoir simulator numerically models the production, injection and subsurface flow of fluids in porous media. These reservoir simulators may also model the flow of fluids in the surface facilities, e.g., wells, pipes, chokes, and/or separators. Reservoir engineers develop field operating policies and procedures in reservoir simulators which then are applied in the operations of the actual reservoir being modeled. The simulator allows the engineer to evaluate different scenarios in a mathematical model before committing resources to the actual field, and to improve the economics of operating the reservoir. For example, the engineer may affect the model results by trying different values for the decision variables or independent variables. For example, exemplary decision variables may include well location and drill times; type of wells to drill; how to operate the wells, e.g., what rates, what injection fluids, and/or when to work-over the wells; and/or size of facilities required at the surface. In a mathematical sense, the field operating policy, as implemented in a reservoir simulator, can include an objective function(s) and potentially one or more constraints. For example, as described by Equation 1:

max[J(u⁰, . . . , uⁿ)]

subject to:

gⁿ(xⁿ⁺¹,xⁿ,uⁿ)=0

cⁿ(xⁿ⁺¹,uⁿ)≦0

L≦uⁿ≦U Equation 1

J represents the objective function that is to be maximized. The objective function is a function of the control parameters at every timestep represented by the array uⁿ. The mathematical model of the reservoir and facilities is represented by g, and the equations describing the physics of the reservoir and facilities are subject to the equations at every timestep. Specifically, g is an array representing the state variables of the reservoir, e.g., pressure, temperature, amounts of various molecules, and cⁿ is an array of constraints at a given timestep n. The control parameters uⁿ are subject to upper and lower bounds (U and L).

The objective function is often written to describe some desirable quantity to be maximized, such as the net present value (NPV) or the flow rate of oil in a production stream. Constraints, on the other hand, describe things that can limit the value of the objective function. Constraints can be applied to the objective function itself, to decision variables and/or to secondary quantities computed by the model. Some of the constraints are based on the laws of physics and cannot be violated. For example, physics-based constraints may include physical limits of pressure drop and flow rate in the wells and surface facilities, and these types of constraints should be honored at every time step in the simulation. Engineers often add additional constraints, such as maximum gas or water rates, composition constraints, e.g., water cut, gas-oil ratio, H₂S concentration, minimum oil rates, and maximum drawdown pressures. The upper or lower bounds (limits) of these engineering constraints are often set based on judgment or experience.

A typical simulator provides the engineer with a way to adjust well rates so as to maximize some objective function subject to constraints. Some reservoir simulators have the ability to describe and enforce the well management policy in the form of a custom computer function. The various techniques that utilize mathematical optimization in the enforcement of well management policy in reservoir simulators can be divided into two general categories: specific-time optimization and over-time optimization. The objective function and constraint values of those techniques that optimize at a specific time are based on the conditions in the simulated reservoir and facilities at a specific time. Accordingly, for a specific time problem, Equation 1 may be simplified to:

max[J(uⁿ)]

subject to:

gⁿ(xⁿ,uⁿ)=0

cⁿ(xⁿ,uⁿ)≦0

LB≦uⁿ≦UB Equation 2

However, the present inventors have determined that specific-time optimization techniques do not fully consider the impact that the current well rates will have on future results. For this reason, specific-time optimization does not typically apply to well location, well timing, or injection. In addition, changing the rate of an injector at the current time, may not impact the production rates for days or months into the future. Therefore, specific-time optimization typically only applies to maximizing the production rate, subject to instantaneous constraints by changing well rates.

The over-time optimization techniques maximize the objective function, taking into account the impact of current well settings on future results. The objective function and constraints for this type of problem can also include over-time effects. However, the present inventors have determined that the optimization over time problem is typically difficult to solve in most practical applications. For example, one must know the future impact of a decision or variable change made in the present. Zakirov et al. suggest a mathematical technique for optimizing well rates in a reservoir simulator over-time in “Optimizing Reservoir Performance by Automatic Allocation of Well Rates,” Presented at 5th European Conference on the Mathematics of Oil Recovery, Leoben Austria, 3-5 Sep. 1996. The technique described by Zakirov utilizes a conjugate gradient technique to solve the constrained optimization problem, where the decision variables are the bottom-hole pressures of each of the wells at each time. For example, for a model with five wells taking 100 timesteps, the Zakirov technique would use 500 unknowns. Further, many optimization algorithms require derivatives of objective functions and constraint values with respect to decision variables. Zakirov utilizes an adjoint technique to calculate the derivatives required by the optimization algorithm. Although Zakirov's adjoint technique offers an efficient way to calculate derivatives for systems of partial differential equations (PDEs), even with adjoints, it is often not practical to compute the necessary derivatives for realistic problems due to the computational expense and required disk storage.

Sarma et al. describe constraint lumping, e.g., for the active constraints, and essentially replaced all the active functions with a differentiable approximation to the max equation in “Production Optimization with Adjoint Models under Non-Linear Control-State Path Inequality Constraints,” SPE 99959, SPE Intelligent Energy Conference and Exhibition. Amsterdam, The Netherlands, 11-13 Apr. 2006. The described Sarma technique is utilized to reduce the cost of computing the derivatives.

Litvak et al. describe a technique which avoids the effort and cost of generating derivatives by using a derivative-free optimization algorithm (Genetic Algorithm) in “Field Development Optimization Technology,” SPE 106426, SPE Reservoir Simulation Symposium. Houston, Tex. 26-28 Feb. 2007. However, typical optimization algorithms that do not use derivatives will also require many function evaluations (simulation runs). In the Litvak example, over 8000 reservoir simulations were run, e.g., single reservoir simulations may take hours or even days to run, which for most realistic models would be very impractical.

Kraaijevanger et al. describe reducing the size of the problem by creating control intervals in “Optimal Waterflood Design Using the Adjoint Method,” SPE 105764 SPE Reservoir Simulation Symposium. Houston, Tex. 26-28 Feb. 2007. The well rate limits or pressure limits are held constant during the control interval. However, the present inventors have determined that this approach can lead to non-physical results when the wells are operating at their physical limits.

While these aforementioned over-time optimization techniques of the background art describe ways to calculate the over-time optimum well rates in reservoir simulators, one or more of these approaches are typically applied to relatively simple reservoir models, e.g., relatively few wells, and smaller and simple grids. In an over-time optimization technique, one must find well rates at every timestep that satisfy Equation 1 to solve this problem in a simple case. In addition, the physically-based equations and/or constraints should be honored at every timestep or a particular run of the simulator will be of little or no value. If there are additional control parameters, such as when to drill new wells or varying separator pressures, the problem becomes even more complex.

### SUMMARY

In view of the foregoing discussion, a need is apparent in the art for an improved tool that can aid reservoir development planning and/or that can provide decision support in connection with reservoir development and resource management, e.g., effectively optimize field operating policy over time. One or more of the following aspects includes one or more methods, systems, and/or computer-readable mediums capable of optimizing an over-time well management policy in conjunction with, or during, reservoir simulation.

Specifically, the present inventors have determined that there are several shortcomings with existing over-time well management optimization techniques, including the aforementioned exemplary techniques of the background art. For example, an issue with the aforementioned over-time optimization techniques arises from the fact that physical constraints must be enforced at every time step. Using the well rates, down-hole devices, and/or chokes as the decision variables in an optimization algorithm does not guarantee that the physical constraints, e.g., pressure/flow relationships in the downstream facilities, will be honored at every timestep of every run of the simulator in the global optimization algorithm. Accordingly, one or more simulations may be wasted in the optimization process.

Although reservoir simulators are often sufficient at predicting field performance, the reservoir simulators are not always accurate when predicting individual well performance. Current over-time optimization techniques produce well rates, or even zone rates for “smart” wells. However, the present inventors have determined that operators in the actual field would benefit from field operating policies and procedures, e.g., rather than specified well rates for individual wells. Another difficulty with over-time optimization techniques that use adjoints is the large amount of data that must be stored. For example, in the aforementioned adjoint techniques of the background art, data must be stored for every well at every timestep, or checkpoint interval, which can be prohibitive. Further, techniques that use derivatives generated using adjoints will likely fail when there are discrete events in the simulation, such as when wells are drilled or shut-in.

The present inventors have also determined that existing well management techniques optimize individual well rates subject to constraints and actions dictated by the well management policy. However, the constraint limits and subsequent actions will, in most cases, have a larger impact on objective functions, such as net present value (NPV), than individual well rates.

In one general aspect, a method for optimizing field operating policy for a subsurface region includes setting initial policy parameters for the subsurface region. Fluid flow within the subsurface region is simulated, including optimizing an objective function for field operating policy. The objective function corresponds simultaneously to modeled fluid flow characteristics of one or more wellbores within the subsurface region and relates to at least one production system performance parameter. Optimizing the objective function for field operating policy includes optimizing the initial policy parameters for the subsurface region with an over-time optimization technique, wherein the policy parameters are optimized for a predetermined policy periods; and determining an enhanced value of the objective function at each timestep within the predetermined policy period. The optimized policy parameters for the predetermined policy period serve as constraints in the determination of an enhanced value of the objective function in the over time-time simulation.

One or more implementations of this aspect may include one or more of the following features. For example, the over-time optimization technique may include at least one over-time optimization technique selected from the group consisting of simulated annealing, genetic algorithms, pattern-based searching, design of experiments, and/or any combination thereof. The over-time optimization technique may include an unconstrained, over-time optimization of the policy parameters for the policy period. Determining the enhanced value of the objective function at each timestep comprises optimizing the objective function at each timestep with a specific-time optimization technique. The specific-time optimization technique may include an optimized rate allocation optimization technique. Determining the enhanced value of the objective function at each timestep may utilize well management logic. The field operating policy may include an objective function for at least one optimal value selected from the group consisting of well rates over time, e.g., one or more of the following: production rate from a production zone within the field, preferential production rates from one or more producing wells that have a specific gas-oil ratio (GOR), a particular water cut, a desired production capacity used to determine a need for drilling new producing wells or installing new surface or subsurface facilities, preferential injection rates or schedules for a portion within the field, and/or any combination thereof. The method may include performing an additional timestep-specific reservoir simulation calculation at each timestep in the predetermined policy period. The additional timestep-specific reservoir simulation calculation may include one or more calculations selected from the group consisting of matrix solution, fluid property calculations, and convergence checking.

In another general aspect, a method for optimizing an over-time optimization problem with a hybrid-optimization technique, the hybrid-optimization technique includes setting initial constraints and decision variables for an objective function defining an over-time optimization problem relating to a hydrocarbon or petrochemical industrial process. The objective function is optimized by optimizing the decision variables for the objective function with an over-time optimization technique, wherein the decision variables are optimized for each of a plurality of predetermined policy periods. An enhanced value of the objective function is determined at each timestep within each of the predetermined policy periods, wherein the optimized policy parameters for the predetermined policy period serve as constraints in the determination of an enhanced value of the objective function in the over-time simulation. A process control associated with the hydrocarbon or petrochemical industrial process is altered based on the determined value of the objective function.

One or more implementations of this aspect may include one or more of the following features. For example, the hybrid-optimization technique may include an unconstrained, over-time optimization of policy parameters for each of the predetermined policy periods. The determination of the enhanced value of the objective function at each timestep may include optimizing the objective function at each timestep with a specific-time optimization technique.

In another general aspect, a tangible computer-readable storage medium having embodied thereon a computer program configured to, when executed by a processor, develop an optimized field operating policy for a subsurface region, the medium comprising one or more code segments configured to set initial policy parameters for the subsurface region; simulate fluid flow within a subsurface region, including to optimize an objective function for field operating policy, the objective function corresponding simultaneously to modeled fluid flow characteristics of one or more wellbores within the subsurface region and relating to at least one production system performance parameter. Code segments for optimizing the objective function for field operating policy may include code segments to optimize the initial policy parameters for the subsurface region with an over-time optimization technique, wherein the policy parameters are optimized for a predetermined policy period; and/or code segments to determine an enhanced value of the objective function at each timestep within the predetermined policy period. The optimized policy parameters for the predetermined policy period may serve as constraints in the determination of an enhanced value of the objective function at each timestep within the predetermined policy period.

One or more implementations of this aspect may include one or more of the following features. For example, the medium may further include one or more code segments configured to determine the enhanced value of the objective function at each timestep with a specific-time optimization technique, wherein the over-time optimization technique includes an unconstrained, over-time optimization of the policy parameters for at least one policy period.

In another general aspect, an exemplary system for optimizing field operating policy for a subsurface region includes a processor; a display unit operatively coupled to the processor; and a memory operatively coupled to the processor. The processor is configured to set initial policy parameters for the subsurface region; simulate fluid flow within a subsurface region, including optimizing an objective function for field operating policy, the objective function corresponding simultaneously to modeled fluid flow characteristics of one or more wellbores within the subsurface region and relating to at least one production system performance parameter. Optimizing the objective function for field operating policy may include the processor being configured to optimize the initial policy parameters for the subsurface region with an over-time optimization technique, wherein the policy parameters are optimized for a predetermined policy period; and/or configured to determine an enhanced value of the objective function at each timestep within the predetermined policy period, wherein the optimized policy parameters for the predetermined policy period serve as constraints in the determination of an enhanced value of the objective function at each timetep within the predetermined policy period.

One or more implementations of this aspect may include one or more of the following features. For example, the system may be operatively connected to production facilities associated with the subsurface region. The system may be operatively configured to store and receive data collected from the production facilities and to send instructions to the production facilities for adjusting one or more process controls associated with the production facilities.

In another general aspect, a method for decision support regarding development of petroleum resources includes optimizing a field operating policy for a subsurface region. Optimizing the field operating policy may include setting initial policy parameters for the subsurface region; simulating fluid flow within a subsurface region, including optimizing an objective function for field operating policy, the objective function corresponding simultaneously to modeled fluid flow characteristics of one or more wellbores within the subsurface region and relating to at least one production system performance parameter. Optimizing the objective function for field operating policy may include optimizing the initial policy parameters for the subsurface region with an over-time optimization technique, wherein the policy parameters are optimized for a predetermined policy period; and/or may include determining an enhanced value of the objective function at each timestep within the predetermined policy period, wherein the optimized policy parameters for the predetermined policy period serve as constraints in the determination of an enhanced value of the objective function at each timestep within the predetermined policy period. An optimized resource development plan generated based on the optimized field operating policy may be provided to assist in producing hydrocarbons from the subsurface region according to the optimized resource development plan.

One or more implementations of this aspect may include one or more of the following features. For example, producing hydrocarbons may include adjusting a process control associated with the subsurface region based on the optimized field operating policy. The optimized field operating policy may include an objective function for at least one optimal value selected from the group consisting of, e.g., one or more of the following of, well rates over time, production rate from a production zone within the field, preferential production rates from one or more producing wells that have a specific gas-oil ratio (GOR), a particular water cut, a desired production capacity used to determine a need for drilling new producing wells or installing new surface or subsurface facilities, preferential injection rates or schedules for a portion within the field, and/or any combination thereof.

In another general aspect, a computer- or software-based method can provide decision support in connection with developing one or more petroleum reservoirs. For example, the method can produce a reservoir development plan based on input data relevant to the reservoir and/or to the operation. Such input data can comprise, unknown or ill-defined fluid dynamics, the size of the reservoir, the current state of development, current and projected prices of petroleum, drilling costs, cost per hour of rig time, geological data, the cost of capital, current and projected available resources (human, financial, equipment, etc.), and the regulatory environment, to name a few representative possibilities.

In another general aspect, a method for reservoir development planning includes receiving data relevant to reservoir development planning, wherein uncertainty is associated with the data. At least some portion of a reservoir development plan is produced in response to processing the received data with a computer-based optimization model that incorporates the uncertainty. One or more corrective decisions are undertaken as the uncertainty unfolds over time.

In another general aspect, a method of producing hydrocarbons from a subterranean reservoir includes generating a reservoir development planning system based on input data. The reservoir development planning system is optimized according to an uncertainty space, wherein the reservoir development planning system is optimized using a Markov decision process-based model. Hydrocarbons are produced from the reservoir according to output from the optimized reservoir development planning system. The input data may include deterministic components and nondeterministic components.

Any foregoing discussion of need in the art is intended to be representative rather than exhaustive. A technology addressing one or more such needs, or some other related shortcoming in the field, would benefit reservoir development planning, for example providing decisions or plans for developing and managing a reservoir more effectively and more profitably. The present invention supports making decisions, plans, strategies, and/or tactics for developing and managing petroleum resources, such as a petroleum reservoir.

### BRIEF DESCRIPTION OF THE DRAWINGS

FIG. 1 is a flowchart of an exemplary process for performing an exemplary reservoir simulation.

FIG. 2 is a schematic view of an exemplary production system having a plurality of wellbores coupled to various surface facilities.

FIG. 3 is a flowchart of an exemplary process for optimizing well management policy for a reservoir within a subsurface region.

FIG. 4 is a flowchart of an exemplary hybrid optimization process that may be implemented in the process of FIG. 3.

FIG. 5 is a schematic view of an exemplary system for reservoir simulation and field operating policy optimization.

Many aspects of the present invention can be better understood with reference to the above drawings. The elements and features shown in the drawings are not necessarily to scale, emphasis instead being placed upon clearly illustrating principles of exemplary embodiments of the present invention. Moreover, certain dimensions may be exaggerated to help visually convey such principles. In the drawings, reference numerals designate like or corresponding, but not necessarily identical, elements throughout the several views.

### DETAILED DESCRIPTION OF THE EXEMPLARY EMBODIMENTS

Exemplary embodiments of the present invention support solving the over-time optimization problem to develop well management policies for a given reservoir. The present inventors have determined that reservoir engineers would prefer to rely upon reservoir simulators to develop well management policies for a given reservoir, e.g., a simulated reservoir typically does not predict exactly how an actual reservoir will behave. Specifically, reservoir engineers will benefit more from a reservoir simulator that is utilized to develop field operating or well management policies, e.g., what actions to take when certain conditions are observed, than they will benefit from a set of well rates over time.

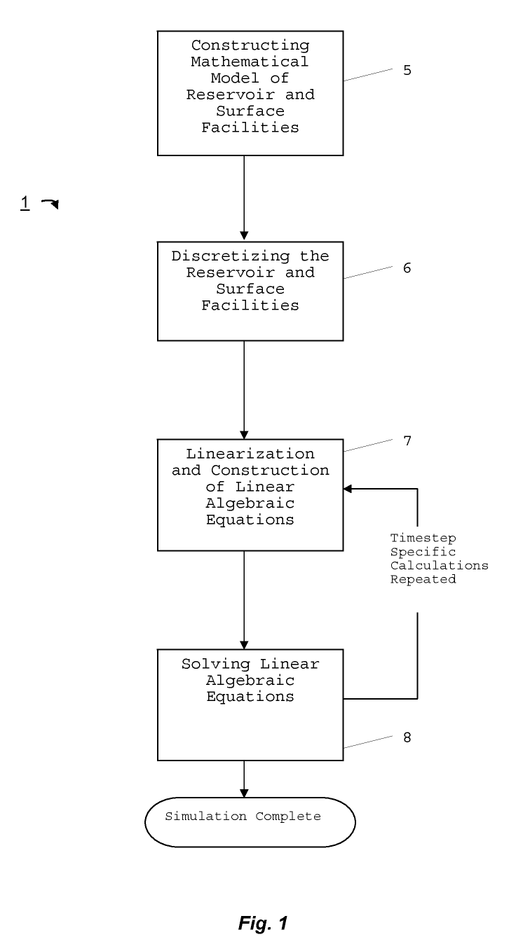

Referring to FIG. 1, an exemplary reservoir simulation process 1 infers the behavior of a real reservoir, or other resource within a subsurface region, from the performance of a model of that reservoir. Reservoir simulations are typically performed using computers as mass transfer and fluid flow processes in petroleum reservoirs are so complex. Computer programs or systems that perform calculations to simulate reservoirs are often referred to as reservoir simulators. The objective of reservoir simulation is to understand the complex chemical, physical, and fluid flow processes occurring in a petroleum reservoir sufficiently well to be able to predict future behavior of a reservoir and to maximize recovery of hydrocarbons. The reservoir simulator can solve reservoir problems that are generally not solvable in any other way. For example, a reservoir simulator can predict the consequences of reservoir management decisions. Reservoir simulation often refers to the hydrodynamics of flow within a reservoir, but in a larger sense it also refers to the total petroleum system which includes the reservoir, the surface facilities, and any interrelated significant activity.

FIG. 1 includes four basic steps in an exemplary reservoir simulation process 1 of a petroleum reservoir. In step 5, a mathematical model of a real reservoir is constructed based on the chemical, physical, and fluid flow processes occurring in the reservoir or other hydrocarbon bearing subsurface region, and any associated surface facilities, e.g., production facilities such as wellbores, flow control devices, and/or platforms. The mathematical model(s) may include a set of nonlinear partial differential equations. In step 6, the reservoir is discretized in both time and space. Space is discretized by dividing the reservoir into suitable gridcells with each gridcell having a set of nonlinear finite difference equations. In step 7, any nonlinear terms that appear in respective nonlinear finite difference equations are linearized and, based on this linearization, linear algebraic equations are constructed, e.g., assembled in a matrix equation. In step 8, the linear algebraic equations assembled in the matrix equation are solved. The simulation proceeds in a series of timesteps, and steps 7 and 8 are iteratively performed at each timestep. The simulation provides a prediction of reservoir behavior, which enables a petroleum engineer to predict reservoir performance, including the rate at which the reservoir can be produced. The accuracy of the model can be checked against the history of the reservoir after the model has been subjected to a simulated recovery process.

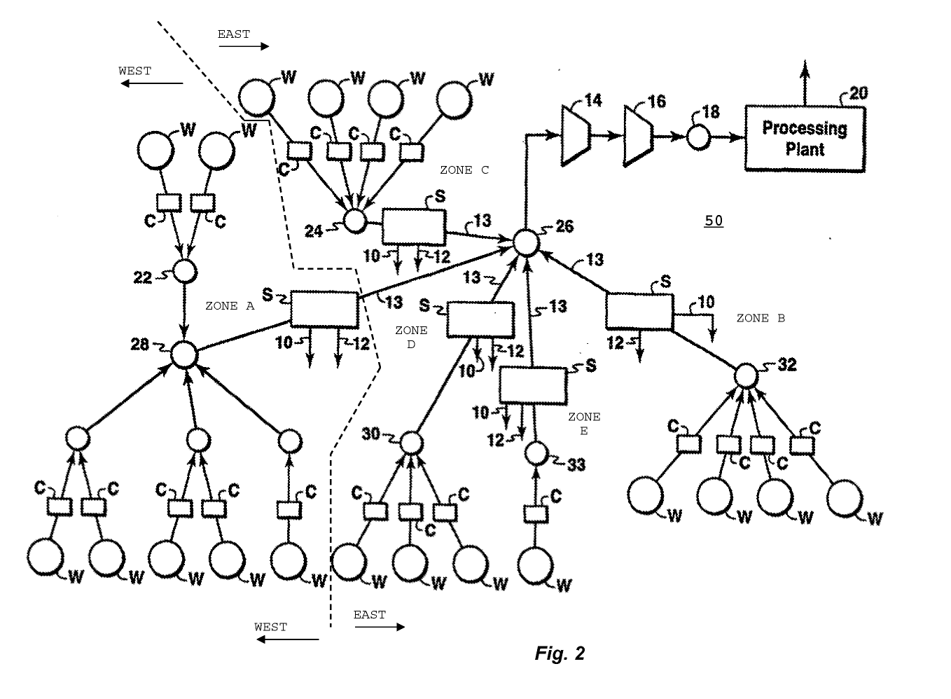

Referring to FIG. 2, an exemplary petroleum production system 50 for a reservoir is shown. The production system includes a plurality of wellbores W, which may penetrate the same reservoir, or a plurality of different subsurface petroleum reservoirs (not shown). The wellbores W are coupled in any manner known in the art to various surface facilities. Each wellbore W may be coupled to the various surface facilities using a flow control device C, such as a controllable choke, or similar fixed or variable flow restriction, in the fluid coupling between each wellbore W and the surface facilities. The flow control device C may be locally or remotely operable. In the exemplary production system 50 shown in FIG. 2, the reservoir is generally characterized by east and west portions, e.g., divided along the dashed line shown in FIG. 2.

The surface facilities may include, for example, production gathering platforms 22, 24, 26, 28, 30, 32 and 33, where production from one or more of the wellbores W may be collected, stored, commingled and/or remotely controlled. Control in this context means having a fluid flow rate from each wellbore W selectively adjusted or stopped. Fluid produced from each of the wellbores W is coupled directly, or commingled with produced fluids from selected other ones of the wellbores W, to petroleum fluid processing devices which may include separators S. The separators S may be of any type known in the art, and are generally used to separate gas, oil and sediment and water from the fluid extracted from the wellbores W. Each separator S may have a gas output 13, and outputs for liquid oil 10 and for water and sediment 12. The liquid oil 10 and water and sediment 12 outputs may be coupled to storage units or tanks (not shown) disposed on one or more of the platforms 22, 24, 26, 28, 30, 32 and 33, or the liquid outputs 10, 12 may be coupled to a pipeline (not shown) for transportation to a location away from the wellbore W locations or the platforms 22, 24, 26, 28, 30, 32 and 33. The gas outputs 13 may be coupled directly, or commingled at one of the platforms, for example platform 26, to serial-connected compressors 14, 16, then to a terminal 18 for transport to a sales line (not shown) or to a gas processing plant 20, which may itself be on a platform or at a remote physical location.

As seen in FIG. 2, the platforms 22, 26, 28, 30, 32, and 33 and all of the associated wellbores W and intermediate components, e.g., flow control devices C and separators S, may optionally be characterized in terms of production zones, e.g., Zone A includes platforms 22 and 28; Zone B includes platform 32; Zone C includes platform 24; Zone D includes platform 30; and Zone E includes platform 33. Alternatively, platform 26, and each of the operatively connected platforms 22, 24, 28, 30, 32, and 33 may also be characterized as a single zone, with each of the aforementioned platforms being part of production subzones (A-E) operatively connected to platform 26. Gas processing plants are known in the art for removing impurities and gas liquids from “separated” gas (gas that is extracted from a device such as one of the separators S). Any one or all of the platforms 22, 24, 26, 28, 30, 32 and 33 may also include control devices for regulating the total amount of fluid, including gas, delivered from the respective platform to the separator S, to the pipeline (not shown) or to the compressors 14, 16.

The production system 50 shown in FIG. 2 is only one example of the types of production systems and elements thereof than can be used in association with one or more of the techniques of the foregoing embodiments. For example, one or more techniques of the foregoing embodiments may include modeling and simulation of fluid flow characteristics of various individual subcomponents in a production system and/or combinations of components up to, and including the entire production system 50. Accordingly, “component” in this context means both the wellbores W and/or one or more components of the surface facilities. Accordingly, the exemplary techniques of the embodiments described hereinafter are not intended to be limited to use with a production system 50 that necessarily includes and/or excludes any one or more of the components of the exemplary system shown in FIG. 2.

Referring to FIG. 2, as some of the wellbores W may be operated to extract particular amounts (at selected rates) of fluid from the one or more subsurface reservoirs (not shown), various quantities of gas, oil and/or water will flow into these wellbores W at rates which may be estimated by solution to reservoir mass and momentum balance equations. Such mass and momentum balance equations are well known in the art for estimating wellbore production. The fluid flow rates depend on relative fluid mobilities in the subsurface reservoir and on the pressure difference between the particular one of the wellbores W and the reservoir (not shown). As is known in the art, as any one or more of the wellbores W is selectively controlled, such as by operating its associated flow control device C, the rates at which the various fluids are produced from each such wellbore W will change, both instantaneously and over time.

The change in fluid production from each wellbore W over time, as is known in the art, is related to the change in pressure and fluid content distribution in the reservoir as fluids are extracted at known rates. These changes in fluid flow rates may also be calculated using mass and momentum balance equations known in the art. Such changes in fluid flow rates will have an effect on operation of the various components of the surface facilities, including for example, the compressors 14, 16, and the separators S. It should be noted that in the exemplary production system 50, any one or more of the wellbores W may be an injector well, e.g., meaning that fluid is not extracted from that wellbore, but that the fluid is pumped into that wellbore. Fluid pumping into a wellbore, as is known in the art, is generally either for disposal of fluid or for providing pressure to the subsurface reservoir (not shown). As a practical matter, the primary difference between an injector well (where injection is into one of the reservoirs) and a producing (fluid extracting) wellbore is that for reservoir simulation purposes, an injector well will act as a source of pressure into the reservoir, rather than a pressure sink from the reservoir.

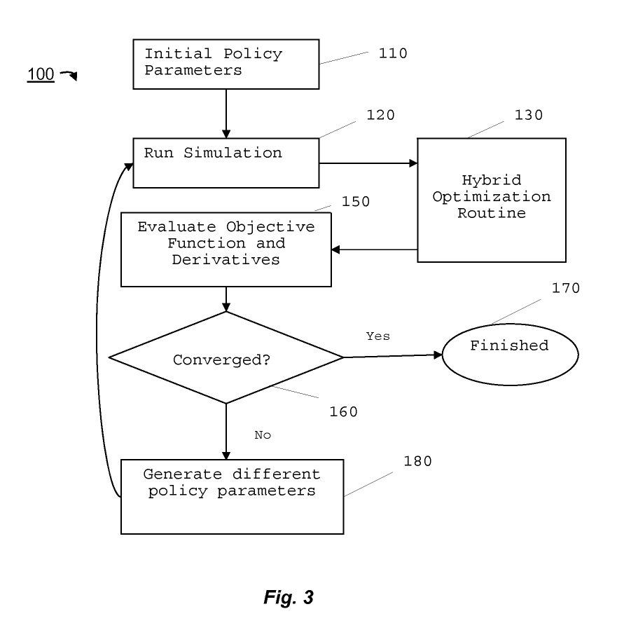

Referring to FIGS. 2-3, one or more of the embodiments depicted relate to solving an optimization over time problem for well management policy, e.g., not necessarily individual well rates over time. For example, referring to FIG. 2, a typical field operating policy may include one or more of maximizing oil rate from a first zone, e.g., wellbores W connected to platform 28 (Zone A) up to a first upper limit (upper limit 1); maximizing oil rate from a second zone, e.g., wellbores W connected to platform 32 (Zone B) up to a second upper limit (upper limit 2); constraining gas rate to an upper limit (upper limit 3); preferentially producing wells that have a low gas-oil ratio (GOR); working over wells W when they reach a particular water cut, e.g., of 0.95; drilling new producing wells W when capacity rates drop below X; injecting produced gas in an east portion of a field for the first n years of production and then injecting water in a west portion; and/or investing in compressors 14, 16 and divert sales gas to gas lift when oil capacity rate drops below a rate r, e.g., 50,000 bbls/day. The actions that this policy specifies are either tied to some condition being observed, a period of time, an allocation method, or a region of the reservoir. With this concept in mind, the present inventors have determined that the problem to be solved is the optimization of well management policy over time, rather than that of individual well rates over time.

Referring to FIG. 3, an exemplary process 100 for optimizing well management policy for a reservoir within a subsurface region, such as the production system 50 of FIG. 2, will be described in greater detail hereinafter. Specifically, process 100 integrates a hybrid optimization approach to solving the over time optimization problem for a production system, e.g., system 50 in FIG. 2, within a subsurface region. For example, any surface facility equations and/or reservoir equations are set up for the production system, and initial conditions in the surface facility and/or reservoir are set, e.g., depending upon whether the well management policy to be optimized relates to the surface facility, reservoir, components of the surface facility and/or the reservoir, and/or any combination thereof. In step 110, an engineer provides initial well management policy parameters, e.g., initial policy parameters for the well management policy being optimized by process 100. In step 120, the reservoir simulation is run forward in time. In step 130, e.g., during the reservoir simulation, a hybrid optimization routine is implemented that permits solving an over time optimization problem and specific time optimization problem while simultaneously satisfying physics-based constraints and policy parameters.

The hybrid optimization routine 130 includes solving the over time well management problem over policy periods, e.g., breaking the full simulation period into well management policy periods, and solving the specific time well management problem over timesteps, e.g., each policy period will include multiple timesteps. At each timestep in the simulation, the well management problem is solved using a specific-time optimization technique. The physical constraints are thereby honored and the policy and actions are enforced at every timestep by solving the well management problem with a specific-time optimization technique at every timestep. However, for the policy periods, the well management problem is solved using over-time optimization techniques, wherein the decision variables are the upper and/or lower bounds on constraints defined in the policy. By choosing the constraint values as the decision variables in the over-time optimization, the solution space is not restricted based on rules-of-thumb or preconceived ideas, but instead the optimizer is afforded more flexibility to determine better solutions.

For example, often optimization algorithms will either find better solutions that are not initially anticipated by engineers or indicate that additional constraints are needed. The non-physics-based constraint limits in the over-time optimization algorithm are thereby optimized. When it is known that a particular constraint cannot be violated, it is not considered a decision variable. In step 130, the simulated time is broken into policy periods (k), and the policy parameters for each policy period (k) are optimized over time. The policy parameters that are optimized over time for each policy period are then set as the constraint limits for the specific-time well management problem. Within a given policy period, the policy is enforced at each timestep by a specific time optimization or management technique, e.g., such as traditional well management logic, or time-specific optimization. Referring to Equation 1, mathematically the over time policy optimization can be represented by Equation 3:

Over-Time Policy Optimization:

max[J′(L⁰ . . . L^{k},U⁰ . . . U^{k})]

subject to:

LB≦L^{k}≦UB

LB≦U^{k}≦UB Equation 3

Where L^{k} and U^{k} represent the lower and upper bounds for constraints or policy trigger points in the policy period k for the specific time problem, and J′ is an over-time objective function that includes the reservoir simulator expression in Equation 1.

Then, for each timestep (n) within policy period (k), the well management problem may be solved by traditional sequential logic methods or by using a specific-time optimization method. For example, once the policy parameters are optimized, the lower L^{k} and upper bounds U^{k} for constraints or policy trigger points in the policy period k are set for the specific time problem, and the specific-time optimization problem within each policy period k may be expressed as Equation 4:

Specific-Time

max[J′(uⁿ)]

subject to:

gⁿ(xⁿ,uⁿ)=0

L^{k}≦cⁿ(xⁿ,uⁿ)≦U^{k}

LB≦uⁿ≦UB Equation 4

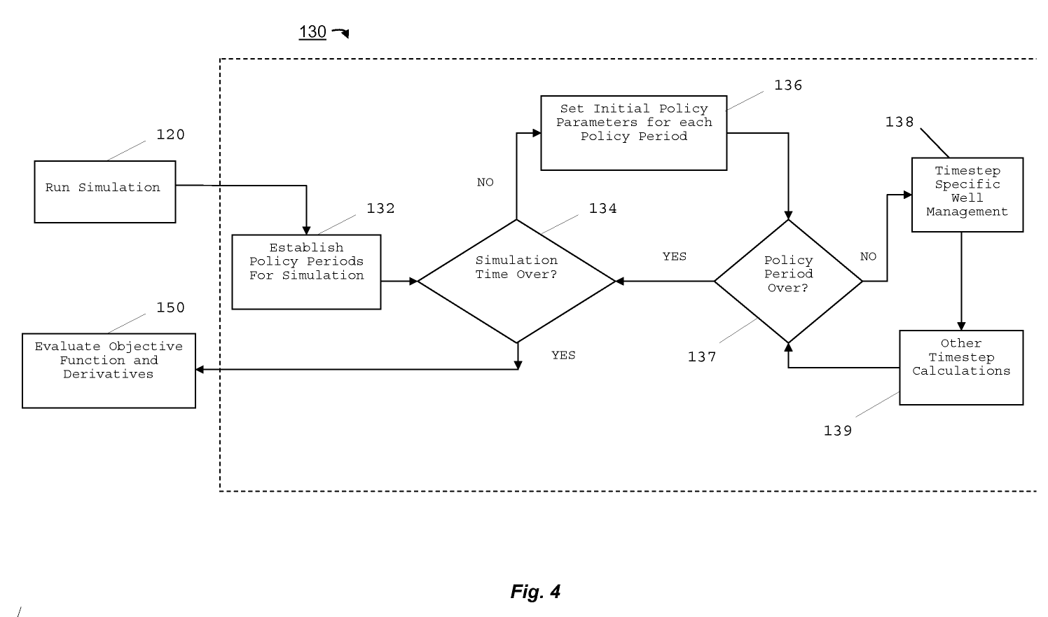

In step 150, the objective function and any associated derivatives that have been determined from the optimization routine 130 are evaluated. In step 160, it is determined if the optimizer has converged. When the optimizer reaches convergence, an optimal value of the objective function is determined When the optimal value of the objective function is determined, the system performance parameter which is represented by the objective function is at an optimal value. If an optimal value of the objective function is not determined, e.g., no convergence, then new policy parameters are generated and the process 100 is repeated starting at step 120 until policy parameters (at each policy period) and the well management problem (at each timestep) are solved with the optimizer and optimal values for the objective function are obtained, e.g., convergence. Although the hybrid optimization routine 130 is represented as a separate step in FIGS. 3 and 4, e.g., that may be embodied on a storage medium separate from the actual reservoir simulator, one of skill in the art will appreciate that one or more, or all of the substeps with routine 130 may actually be performed as part of simulation step 120, e.g., and thus incorporated into an overall reservoir simulator system.

In step 150, the objective function is calculated. The objective function can be anything the engineer chooses, such as for a typical over-time problem, net present value (NPV). Numerous assumptions may go into the calculation of NPV and the level of detail may vary from one engineer to the next. However, a typical NPV calculation will include the value of the oil and gas streams, minus the cost of handling the water stream. Additional complexity may be experienced if the cost of drilling wells, the cost of performing workovers, the cost of installing compressors and/or separators, and/or taxes are included in the calculation. All of these quantities may be summed and appropriately weighted by the time-value of money. Alternatively, another objective function may be the cumulative oil recovery from the reservoir. The derivative calculation involves determining the sensitivity of the objective function to the over-time decision variables, which can be accomplished in many ways. For example, one relatively simple approach is to use finite difference analysis. However, one of the advantages of the hybrid optimization process is that derivatives may not need to be calculated for every over-time decision variable, e.g., as only those decision variables that are active influence the specific time problem. Specifically, the over-time decision variables that do not influence the specific time problem will naturally have a derivative of zero. Accordingly, derivative calculations may not be necessary depending upon the overtime algorithm that is chosen.

In step 160, the engineer may select one or more of a variety of ways of determining if the optimizer has converged. For example, convergence may be determined if the objective function is at a maximum bound, e.g., is the NPV sufficiently high. Alternatively, has the desired improvement in the objective function sufficiently slowed or stopped with each successive calculation, e.g., has the desired degree of mathematical optimality been achieved with the most recent calculations.

FIG. 4 is a flowchart of an exemplary hybrid optimization process 130 that may be implemented in the process of FIG. 3. Referring to FIG. 4, an exemplary hybrid optimization process 130 may include the following steps, which may be performed by an optimizer containing a solution algorithm configured to perform process 130. In step 132, the simulation time is broken into policy periods (k), e.g., policy periods of predetermined duration, such as breaking the simulation period into four policy periods of equal duration. The policy periods (k) set the time period for performing an unconstrained, over time optimization. In step 134, the optimizer determines if the simulation time is over, e.g., if all timesteps and policy periods have already been run for the simulation time period. If the optimizer determines that the simulation time period is over, the process proceeds to step 150, e.g., the objective function and any derivatives are evaluated and convergence is evaluated in step 160.

If the optimizer determines that the simulation time period is not over, the process proceeds to step 136, where the initial policy parameters for the respective policy period are set, e.g., an unconstrained, over time optimization is performed to determine the policy parameters to serve as the constraints in the specific time optimization at each timestep within the policy period. In step 136, if the policy period is not over, the specific time optimization or well management solution is performed for each timestep (step 138), e.g., with the constraints for the specific-time optimization being determined by the over time optimization in step 136. The well management problem is solved to satisfy both physics-based constraints and policy parameters. Then, in step 138, any additional timestep calculations, such as may be typical with reservoir simulators, including matrix solution, property calculations, and convergence checking, are also performed. Steps 137-139 are continuously performed for each subsequent timestep until the well management policy period is complete. In step 134, once the well management policy period is determined to be complete, e.g., step 137, the optimizer determines if the simulation time period is over. If the optimizer determines that the simulation time period is not over, a new policy period is initiated and process steps 136-139 are repeated as described above for the new policy period. If the optimizer determines that the simulation time period is over, the process proceeds to step 150, e.g., to evaluate the objective function and derivatives provided by the hybrid optimization routine 130.

The present inventors have determined that there are several advantages to formulating the well management over-time problem in this two-level approach. First, by solving the specific-time problem every timestep, all physics-based constraints are guaranteed to be honored. In contrast, well management optimization methods that attempt to solve for the globally optimal well rates at every timestep will have difficulty generating simulations that always honor the laws of physics. Second, the outer optimization loop for policy periods, e.g., over time optimization problem, is an unconstrained optimization problem. Instead, all of the constraints are handled at the time-specific problem. Therefore, bounds are easily enforced on the policy parameters without introducing optimization constraints. The optimizer may incorporate various optimization algorithms through the aforementioned embodiments. For example, by not having constraints in the outer optimization problem, the reservoir engineer is afforded greater flexibility in choosing optimization algorithms. The aforementioned process also reduces the computational complexity of the over time optimization problem, e.g., by not having to generate and store as much derivative information.

Alternatively, the aforementioned hybrid optimization approach may be applied to the optimization of other process simulations, e.g., any process, including those unrelated to oil and gas exploration and production such as complex manufacturing processes, where control parameters need to be adjusted during the course of the simulation.

In the aforementioned embodiments, the size of the over time optimization problem is not tied to the number of wells and the number of timesteps in the simulation as in other over-time optimization algorithms. Accordingly, the engineer may limit the number of decision variables by increasing the size of the policy periods and limiting the number of policy parameters to be optimized. Initial screening runs may be used to determine which policy parameters most affect the overall result and thereby eliminate those policy parameters that have less impact. As the aforementioned embodiments reduces the number of decision variables in the over-time optimization problem, derivative free-algorithms may be used, e.g., that do not typically have problems with discrete events, such as drilling or working over a well, or other binary decisions that are often made in well management policies.

Exemplary algorithms that can be used in process 100 include, but are not limited to, simulated annealing, genetic algorithms, pattern-based searching, and/or design of experiments. The specific time optimization problem may be solved by a variety of techniques. For example, the specific time optimization problem may be solved using an optimized rate allocation technique, such as that described in U.S. Pat. No. 7,379,853 (Middya), entitled “Method for Enhancing Production Allocation in an Integrated Reservoir and Surface Flow System,” which issued on May 27, 2008, the entire contents of which are hereby incorporated by reference. Specifically, U.S. Pat. No. 7,379,853 describes one or more exemplary methods for enhancing allocation of fluid flow rates among a plurality of wellbores coupled to surface facilities, and more specifically, examples of optimizing an objective function corresponding to modeled fluid flow characteristics of a production system to determine an enhanced value. Fluid flow characteristics of the wellbores and at least one reservoir penetrated by the wellbores are modeled, along with any surface facilities. An optimizer is operated to determine an enhanced value of an objective function. The objective function corresponds simultaneously to the modeled fluid flow characteristics of the wellbores and/or the surface facilities. The objective function also relates to one or more production system parameter(s), e.g., such as maximum oil production rate.

The specific time problem may alternatively be solved by well management logic, such as that described in international patent application number PCT/US2006/015385, which corresponds to U.S. patent application Ser. No. 11/922,720, (Do et al.), entitled High-Level Graphical Programming Language and Tool for Well Management Programming, which published on Jan. 4, 2007, as WO 2007/001604. In publication WO 2007/001604, examples of integrating well management programming or well management logic techniques into reservoir simulation programs are described that may also be integrated into the above-described embodiments when solving the specific time problem described in the aforementioned embodiments.

For example, the aforementioned hybrid optimization technique may be integrated directly into a reservoir simulation process. The computer program(s) used to build a reservoir simulation model that adequately characterize rock and fluid properties, e.g., within the subsurface and any associated surface facilities, are also used to calculate the evolution of the simulation model over time in response to planned well operations to remove saleable fluids and in some cases to replace these with less valuable fluids to maintain pressure. The optimizer may be directly integrated into the reservoir simulation computer program. A typical reservoir simulation model is built by subdividing (discretizing or gridding) a volume of interest into a large number of polyhedral cells. The number of cells commonly ranges from tens of thousands to a few million. The volume of interest is defined areally and vertically by the extent of the oil and gas accumulation and of the water that is in pressure communication with the oil and gas. The area may be several square miles, and the thickness may be hundreds, or even thousands of feet. The state of a simulation cell is defined by its pressure and its contents, i.e., the amounts of oil, gas, and water within the cell. The goal of simulation is to calculate the evolution through time of the states of the cells. This evolution may be governed by the initial states and by the time-dependent removal of fluid from (production) or addition of fluid to (injection) the system by way of wells.

The state of a cell changes in time because of fluid flow between pairs of neighboring cells or between a cell and a well. Fluid flows from high pressure to low pressure. Pressure gradients are induced by removing fluid from the reservoir (production) or adding fluid to the reservoir (injection) by way of wellbores that penetrate the porous and permeable rock. Within the reservoir, fluid converges on (flows toward) producing wellbores and diverges from (flows away from) injecting wellbores. In the context of an exemplary finite-difference reservoir simulation model, fluid flows are calculated between pairs of neighboring cells, and for cells penetrated by a wellbore, between the cell and the wellbore. For purposes of modeling fluid flow, approximate versions of the relevant equations are written for cells to express the conservation of mass and the relationship between phase flow rate and pressure difference. The simultaneous (approximate) solution of these equations for the collection of cells yields the pressure and contents of each cell at a single time. The equations may be solved to determine the state of the reservoir at each point in time subject to boundary conditions, such as sink and source terms, which describe how much fluid is injected into or removed from wells located at various positions in the simulation model.

The sink and source terms that represent well operating rates may be set differently when running a simulation study. To begin, a history match process may be utilized to validate a simulation model. To assure that the simulation model is a good representation of the actual reservoir, the simulation model is calibrated using historical performance data, which often includes measurements at regular intervals of produced fluid volumes and periodic measurements of pressures in wells. In this phase, the source and sink terms are specified using the data collected for well rates. Then, the simulation model is performed and reservoir properties are adjusted to correspond with the data observed from the field.

After the simulation model is validated, it may then be used to provide predictions to forecast future reservoir and well performances. In this mode of operation, the sink and source terms may be specified even though data for well rates are not available for dates projected into the future. The simulation model may be used to investigate many possible prediction scenarios. For each scenario, some settings may be selected for the set of boundary conditions to investigate possible strategies for operating the reservoir and to comply with various operating constraints. Whether in history match or in prediction mode, selecting and specifying the boundary conditions to operate a simulation model may not be a simple process and, in many cases, may involve extensive programming. In prediction mode, programming is often utilized to set the well rates and boundary conditions. The program written to set these well rates and boundary conditions for a simulation model is often referred to as well management logic or well management program. As such, the well management program is an added component to the reservoir simulation program used to solve the reservoir equations.

Well management programs are generally designed to be flexible and to address many types of requirements for a reservoir. The program typically includes many steps or blocks of code executable in a predefined sequence for purposes of analyzing constraints and requirements imposed on facilities. If any constraint is violated, the program may perform a series of adjustments to modify well operating conditions until the constraint is no longer violated. For each constraint violation, a number of adjustments may be made and a number of different wells may be candidates for the adjustments. After the well management program is developed and coded, it is typically compiled and linked with the rest of the reservoir simulator code, and the resulting combined software package is used to make prediction studies for the reservoir.

Accordingly, one or more of the foregoing embodiments may utilize a programming solution, such as the solution described in further detail in publication WO 2007/001604 which is based on developing a layer of components supported by a graphical interface to create a high-level programming approach. An exemplary computer program for the above-described optimization process 100, can be created using a special high-level language through a graphical environment. The resulting program is then converted to a low-level programming language, such as C++, FORTRAN and the like, which may later be compiled and linked to the reservoir simulation program.

In summary, the present inventors have determined that the aforementioned hybrid optimization technique is an improvement over one or more methods of the background art as the hybrid optimization technique works on realistic reservoir simulations, generates an optimized well management policy that can be more easily translated into practice, handles discontinuities that exist in almost every reservoir simulation model, permits easy changing of the size of the model so that only the most controlling parameters are optimized, and/or the solution method guarantees all of the physical constraints are honored at every time step.

The terms “optimal,” “optimizing,” “optimize,” “optimality,” “optimization” (as well as derivatives and other forms of those terms and linguistically related words and phrases), as used herein, are not intended to be limiting in the sense of requiring the present invention to find the best solution or to make the best decision. Although a mathematically optimal solution may in fact arrive at the best of all mathematically available possibilities, real-world embodiments of optimization routines, methods, models, and processes may work towards such a goal without ever actually achieving perfection. Accordingly, one of ordinary skill in the art having benefit of the present disclosure will appreciate that these terms, in the context of the scope of the present invention, are more general. The terms can describe working towards a solution which may be the best available solution, a preferred solution, or a solution that offers a specific benefit within a range of constraints; or continually improving; or refining; or searching for a high point or a maximum for an objective; or processing to reduce a penalty function; etc.

In certain exemplary embodiments, an optimization model can be an algebraic system of functions and equations comprising (1) decision variables of either continuous or integer variety which may be limited to specific domain ranges, (2) constraint equations, which are based on input data (parameters) and the decision variables, that restrict activity of the variables within a specified set of conditions that define feasibility of the optimization problem being addressed, and/or (3) an objective function based on input data (parameters) and the decision variables being optimized, either by maximizing the objective function or minimizing the objective function. In some variations, optimization models may include non-differentiable, black-box and other non-algebraic functions or equations.

An exemplary reservoir simulator and optimizer may be implemented, for example, using one or more general purpose computers, special purpose computers, analog processors, digital processors, central processing units, and/or distributed computing systems. For example, the reservoir simulator can include computer executable instructions or code. The output of the reservoir simulator can comprise a result displayed on a graphical user interface (GUI), a data file, data on a medium such as an optical or magnetic disk, a paper report, or signals transmitted to another computer or another software routine (not an exhaustive list).

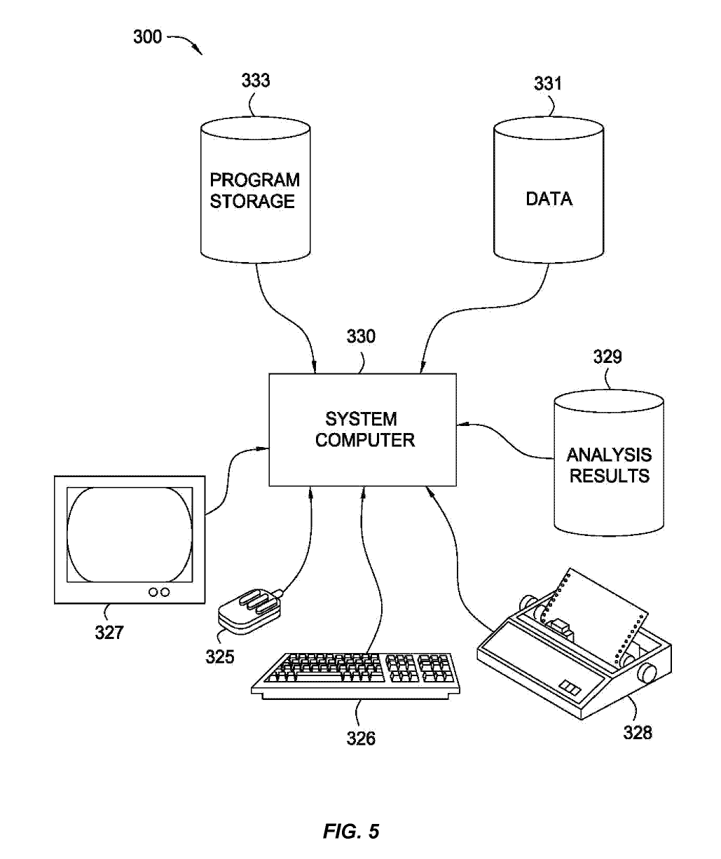

Referring to FIG. 5, an exemplary reservoir simulation system is supported by a computer network 300, into which embodiments of the invention may be implemented. The computer network 300 includes one or more system computers 330 and associated client devices (not shown), which may be implemented as any conventional personal computer or workstation, such as a UNIX-based workstation. The system computer 330 is in communication with disk storage devices 329, 331, and 333, which may be external hard disk storage devices. It is contemplated that disk storage devices 329, 331, and 333 are conventional hard disk drives, and as such, will be implemented by way of a local area network or by remote access. Of course, while disk storage devices 329, 331, and 333 are illustrated as separate devices, a single disk storage device may be used to store any and all of the program instructions, measurement data, and results as desired.

In one embodiment, the input data are stored in disk storage device 331. The system computer 330 may retrieve the appropriate data from the disk storage device 331 to solve the implicit reservoir simulation and optimization equations according to program instructions that correspond to the methods described herein. The program instructions may be written in a computer programming language, such as C++, Java and the like. The program instructions may be stored in a computer-readable memory, such as program disk storage device 333. Of course, the memory medium storing the program instructions may be of any conventional type used for the storage of computer programs, including hard disk drives, floppy disks, CD-ROMs and other optical media, magnetic tape, and the like.

According to a preferred embodiment, the system computer 330 presents output primarily onto graphics display 327, or alternatively via printer 328. The system computer 230 may store the results of the methods described above on disk storage 329, for later use and further analysis. The keyboard 326 and the pointing device (e.g., a mouse, trackball, or the like) 225 may be provided with the system computer 330 to enable interactive operation. The system computer 330 may be located at a data center remote from the reservoir(s) or subsurface region. While FIG. 3 illustrates the disk storage 331 as directly connected to the system computer 330, it is also contemplated that the disk storage device 331 may be accessible through a local area network or by remote access. Furthermore, while disk storage devices 329, 331 are illustrated as separate devices for storing input data and analysis results, the disk storage devices 329, 331 may be implemented within a single disk drive (either together with or separately from program disk storage device 333), or in any other conventional manner as will be fully understood by one of skill in the art having reference to this specification.

The reservoir model and reservoir simulator may be used to simulate the operation of the reservoir to thereby permit modeling of fluids, energy, and/or gases flowing in the hydrocarbon reservoirs, wells, and related surface facilities. Reservoir simulation is one part of reservoir optimization which also includes constructing the data to accurately represent the reservoir. An exemplary simulation goal comprises understanding formation flow patterns in order to optimize some strategy for producing hydrocarbons from some set of wells and surface facilities. The simulation is usually part of a time-consuming, iterative process to reduce uncertainty about a particular reservoir model description while optimizing a production strategy. Reservoir simulation, for example, is one kind of computational fluid dynamics simulation. The reservoir model and the reservoir simulator may further be used to optimize the design and operation of the corresponding reservoir, wells, and related surface facilities.

One or more of the aforementioned embodiments can include multiple processes that can be implemented with computer and/or manual operation. The aforementioned techniques can be implemented with one or more computer programs that embody certain functions described herein and illustrated in the accompanying figures. However, it should be apparent that there could be many different ways of implementing aspects of the present invention with computer programming, manually, non-computer-based machines, or in a combination of computer and manual implementation. Further, a programmer with ordinary skill would be able to write such computer programs without difficulty or undue experimentation based on the disclosure and teaching presented herein. Therefore, disclosure of a particular set of program code instructions is not considered necessary for an adequate understanding of how to make and use the aforementioned embodiments. The inventive functionality of any programming aspects of the present invention will be explained in further detail in the following description in conjunction with the figures illustrating the functions and program flow and processes.

In various exemplary embodiments, one or more aspects of process 100 can be implemented using a mathematical programming language or system such as, for example, AIMMS, GAMS, AMPL, OPL, Mosel or using a computer programming language such as, for example, C++ or Java, or some combination of both. The solution routines may be developed in either mathematical programming languages or directly with a computer programming language or with support of commercially available software tools. For example, commercial and open source versions of mathematical programming languages and computer programming code compilers are generally available.

It is understood that variations may be made in the foregoing without departing from the scope and spirit of the invention. Although illustrative embodiments of the present invention have been shown and described, a wide range of modification, changes and substitution is contemplated in the foregoing disclosure. In some instances, some features of the present invention may be employed without a corresponding use of the other features. Accordingly, it is appropriate that the appended claims be construed broadly and in a manner consistent with the scope and spirit of the invention.

What is claimed is:

1. A method for optimizing field operating policy for a subsurface region, comprising:
setting initial policy parameters for the subsurface region;
simulating fluid flow within a subsurface region, including optimizing an objective function for field operating policy, the objective function corresponding simultaneously to modeled fluid flow characteristics of one or more wellbores within the subsurface region and relating to at least one production system performance parameter, wherein optimizing the objective function for field operating policy comprises:
optimizing the initial policy parameters for the subsurface region with an over-time optimization technique, wherein the policy parameters are optimized for a predetermined policy periods; and
determining an enhanced value of the objective function at each timestep within the predetermined policy period, wherein the optimized policy parameters for the predetermined policy period serve as constraints in the determination of an enhanced value of the objective function in the over time-time simulation.

2. The method according to claim 1, wherein the over-time optimization technique comprises at least one over-time optimization technique selected from the group consisting of: simulated annealing, genetic algorithms, pattern-based searching, design of experiments, and any combination thereof.

3. The method according to claim 1, wherein the over-time optimization technique comprises an unconstrained, over-time optimization of the policy parameters for the policy period.

4. The method of claim 1, wherein determining the enhanced value of the objective function at each timestep comprises optimizing the objective function at each timestep with a specific-time optimization technique.

5. The method of claim 4, wherein the specific-time optimization technique comprises an optimized rate allocation optimization technique.

6. The method of claim 5, wherein determining the enhanced value of the objective function at each timestep utilizes well management logic.

7. The method of claim 1, wherein the field operating policy comprises an objective function for at least one optimal value selected from the group consisting of well rates over time, production rate from a production zone within the field, preferential production rates from one or more producing wells that have a specific gas-oil ratio (GOR), a particular water cut, a desired production capacity used to determine a need for drilling new producing wells or installing new surface or subsurface facilities, preferential injection rates or schedules for a portion within the field, and any combination thereof.

8. The method of claim 1, further comprising performing an additional timestep-specific reservoir simulation calculation at each timestep in the predetermined policy period.

9. The method of claim 9, wherein the additional timestep-specific reservoir simulation calculation comprises one or more calculations selected from the group consisting of matrix solution, fluid property calculations, and convergence checking.

10. A method for optimizing an over-time optimization problem with a hybrid-optimization technique, the hybrid-optimization technique comprising:
setting initial constraints and decision variables for an objective function defining an over-time optimization problem relating to a hydrocarbon or petrochemical industrial process;
optimizing the objective function by optimizing the decision variables for the objective function with an over-time optimization technique, wherein the decision variables are optimized for each of a plurality of predetermined policy periods; and
determining an enhanced value of the objective function at each timestep within each of the predetermined policy periods, wherein the optimized policy parameters for the predetermined policy period serve as constraints in the determination of an enhanced value of the objective function in the over-time simulation; and
altering a process control associated with the hydrocarbon or petrochemical industrial process based on the determined value of the objective function.

11. The method of claim 10, wherein the hybrid-optimization technique comprises an unconstrained, over-time optimization of policy parameters for each of the predetermined policy periods.

12. The method of claim 11, wherein determining the enhanced value of the objective function at each timestep comprises optimizing the objective function at each timestep with a specific-time optimization technique.

13. A tangible computer-readable storage medium having embodied thereon a computer program configured to, when executed by a processor, develop an optimized field operating policy for a subsurface region, the medium comprising one or more code segments configured to:
set initial policy parameters for the subsurface region;
simulate fluid flow within a subsurface region, including to optimize an objective function for field operating policy, the objective function corresponding simultaneously to modeled fluid flow characteristics of one or more wellbores within the subsurface region and relating to at least one production system performance parameter, wherein optimizing the objective function for field operating policy comprises:
optimize the initial policy parameters for the subsurface region with an over-time optimization technique, wherein the policy parameters are optimized for a predetermined policy period; and
determine an enhanced value of the objective function at each timestep within the predetermined policy period, wherein the optimized policy parameters for the predetermined policy period serve as constraints in the determination of an enhanced value of the objective function at each timestep within the predetermined policy period.

14. The tangible computer-readable storage medium of claim 14, the medium further comprising one or more code segments configured to determine the enhanced value of the objective function at each timestep with a specific-time optimization technique and wherein the over-time optimization technique comprises an unconstrained, over-time optimization of the policy parameters for at least one policy period.

15. A system for optimizing field operating policy for a subsurface region, comprising:
a processor;
a display unit operatively coupled to the processor; and
a memory operatively coupled to the processor, the processor being configured to:
set initial policy parameters for the subsurface region;
simulate fluid flow within a subsurface region, including optimizing an objective function for field operating policy, the objective function corresponding simultaneously to modeled fluid flow characteristics of one or more wellbores within the subsurface region and relating to at least one production system performance parameter, wherein optimizing the objective function for field operating policy comprises:
optimize the initial policy parameters for the subsurface region with an over-time optimization technique, wherein the policy parameters are optimized for a predetermined policy period; and
determine an enhanced value of the objective function at each timestep within the predetermined policy period, wherein the optimized policy parameters for the predetermined policy period serve as constraints in the determination of an enhanced value of the objective function at each timetep within the predetermined policy period.

16. The system of claim 15, wherein the system is operatively connected to production facilities associated with the subsurface region.

17. The system of claim 16, wherein the system is operatively configured to store and receive data collected from the production facilities and to send instructions to the production facilities for adjusting one or more process controls associated with the production facilities.

18. A method for decision support regarding development of petroleum resources, comprising:
optimizing a field operating policy for a subsurface region, wherein optimizing the field operating policy comprises:
setting initial policy parameters for the subsurface region;
simulating fluid flow within a subsurface region, including optimizing an objective function for field operating policy, the objective function corresponding simultaneously to modeled fluid flow characteristics of one or more wellbores within the subsurface region and relating to at least one production system performance parameter, wherein optimizing the objective function for field operating policy comprises:
optimizing the initial policy parameters for the subsurface region with an over-time optimization technique, wherein the policy parameters are optimized for a predetermined policy period; and
determining an enhanced value of the objective function at each timestep within the predetermined policy period, wherein the optimized policy parameters for the predetermined policy period serve as constraints in the determination of an enhanced value of the objective function at each timestep within the predetermined policy period; and
providing an optimized resource development plan generated based on the optimized field operating policy; and
producing hydrocarbons from the subsurface region according to the optimized resource development plan.

19. The method according of claim 18, wherein producing hydrocarbons comprises adjusting a process control associated with the subsurface region based on the optimized field operating policy.

20. The method according to claim 18, wherein the optimized field operating policy comprises an objective function for at least one optimal value selected from the group consisting of well rates over time, production rate from a production zone within the field, preferential production rates from one or more producing wells that have a specific gas-oil ratio (GOR), a particular water cut, a desired production capacity used to determine a need for drilling new producing wells or installing new surface or subsurface facilities, preferential injection rates or schedules for a portion within the field, and any combination thereof.
